(19) United States
(12) Patent Application Publication
(10) Pub. No.: US 2010/0037910 A1
(43) Pub. Date: Feb. 18, 2010

(54) APPLICATOR

(75) Inventors: Rolf Müller-Grünow, Köln (DE); Andreas Wietzke, München (DE)

Correspondence Address: CONNOLLY BOVE LODGE & HUTZ LLP, PO BOX 2207, WILMINGTON, DE, 19899-2207, US

(73) Assignee: HENKEL AG & CO. KGAA, Düsseldorf (DE)

(21) Appl. No.: 12/513,691

(22) PCT Filed: Oct. 25, 2007
(86) PCT No.: PCT/EP2007/061477

§ 371 Date: May 6, 2009

(30) Foreign Application Priority Data
Nov. 10, 2006 (DE) 102006053401.8

(51) Int. Cl. A61Q 5/10; A45D 24/22; A45D 24/16; A45D 19/18

(52) U.S. Cl. 132/208; 132/112; 132/120; 132/270

(57) ABSTRACT

The present invention relates to an applicator for applying a product onto keratin-containing fibers or fiber bunches, comprising at least one application element and at least one selection element.

The present invention relates to an applicator for applying a product onto keratin-containing fibers or fiber bunches, comprising at least one application element and at least one selection element.

Application apparatuses of this kind are already known in the existing art. U.S. Pat. No. 3,030,968, for example, presents a forceps-shaped apparatus having a depression for the reception of product on the one forceps side, and a protrusion on the other forceps side. When a hair or hair strand is placed, in the context of an apparatus according to this existing art, over the depression for the product and the forceps is closed, the protrusion serves to immerse the hair into the product contained in the depression. A disadvantage with such apparatuses is that the apparatus must be held horizontally during the entire utilization period in order to ensure that the product remains in the depression. This cannot be ensured specifically when coloring hair at inaccessible locations, for example at the back of the head, and a great risk therefore exists of spilling the product and thus unintentionally contaminating hair or clothing. A further disadvantage of this apparatus is the absence of an apparatus for picking out, selecting, and gripping the hair strand. This operation must be performed manually. This manual selection is additionally complicated by the fact that gloves must usually be worn when coloring keratinic fibers, and the sensitivity in fingers and fingertips necessary for selecting and gripping hair strands is thus greatly limited,

The American patent document U.S. Pat. No. 7,025,069 B2 likewise presents an applicator for applying a product onto keratin-containing fibers or fiber bunches. In contrast to the apparatus of U.S. Pat. No. 3,030,968 that has already been described, what is referred to here is not a forceps-like apparatus but a scissor-like one. In addition, it comprises a selection element that serves to grip a hair strand. Here as well, the application operation itself is accomplished by immersing the hair strand, by means of a protrusion on the one scissors side, into the depression on the other scissors side containing the product. This apparatus according to the existing art also exhibits the utilization-related problems already described.

The object of the present invention is to solve the problems of the existing art. A further problem with the apparatuses of the existing art is the impractical stocking of product in an open depression. The apparatuses of the existing art also do not exhibit a separate application element.

These problems are solved by the features in accordance with Claim 1.

An applicator according to the present invention serves for application of a product onto keratin-containing fibers or fiber bunches. The applicator comprises at least one application element and at least one selection element. The application element serves for application of the product onto the keratinic fibers or the fiber bunch. The selection element serves for selection of a keratinic fiber or a fiber bunch from a large quantity of keratinic fibers, for example to select individual strands in the case of hair on the human head.

In contrast to the apparatuses of the existing art, with the present invention the application element and selection element are arranged in a manner physically separated from one another, but connected into one applicator. It is thereby possible to avoid contamination of the selection element by the product before, during, or after the application operation. Such contamination would be problematic, since applicator apparatuses of this kind are usually used to color multiple fiber bunches or fibers in succession. In this case a contaminated selection element would already, at only the second selection operation, inadvertently contaminate all the fibers with which it comes into contact during the selection operation. For the case in which the product is a hair coloring agent, the color result would not be, as desired, the exclusive coloring of individual hair strands, but would instead be characterized by many small colored spots caused by the contaminants.

In order to ensure, in the context of the apparatus according to the present invention, that it is usable without difficulty even in difficult positions, for example at the back of the head, the application element is connected to the opening of a container that contains the product. The application element is thus supplied with product from the container. This ensures that in addition to supplying the application element with product, no inadvertent contamination occurs, in particular of surrounding hair or of the user's garments.

In the context of the present invention, it may be advantageous to select the corresponding appropriate application element depending on the type of keratin-containing fibers or fiber bunches. In this context, the application element can contain, for example, bristles, comb elements, sintered elements, or sponge elements, or also a combination of such elements. In any case, it is useful to adapt the application element to the product being applied. Liquid products of all imaginable viscosities, but also products in powdered, granulated, or gel form, are conceivable within the scope of the invention.

If the product is a hair coloring agent, it may be advantageous to provide a combination of bristles and comb elements, so that the hair fibers are brought by the comb elements into a position advantageous for the application operation, and the hair coloring agent is uniformly applied by the bristles onto all the hairs. For non-permanent hair colors, which often have a lower viscosity, it may be advantageous to use a combination of comb elements and sintered elements, so that individual hair strands can be colored as if with a felt-tip pen. In this context the sintered elements serve at the same time, because of the capillary force resulting from the fine pores, to convey the product out of the container to the hair strands.

Sponge elements and other fiber elements are, of course, also conceivable as application elements.

It may be advantageous in the context of the present invention to configure the selection element in an elongated and substantially spatula-like shape. Particularly preferably, the selection element can have a barb at the end. The elongated, spatula-shaped embodiment ensures that the application zone is located at a physical distance from the region with which the hair strand to be colored is separated from the remaining surrounding hair. This is the only way to ensure that the selection element does not become contaminated with product even in the context of multiple application. To make selection even simpler for the user of an apparatus according to the present invention, it may be advantageous to place a barb in the shape of a crochet hook at the tip of the selection element, so that it can more easily select and hold the hair strand he or she chooses.

The field of application of an applicator according. to the present invention is usually defined by the circumference and the geometric configuration of the application element. All the above-described conformations of the application element involve application forms that bring the product into contact with the fiber. In this case, the geometrical development of the application element is substantially identical to the application region. When the applicator according to the present invention is used, the fiber or fiber bunch to be colored is moved along the application element inside this application region, so that the entire fiber is wetted from beginning to end with product.

To ensure that during this application operation, i.e. during movement of the hair fiber through the application region, the hair fiber also remains in that region, it is advantageous to provide a guide that is formed, for example, by a groove. It is immaterial in terms of the functionality of the present invention whether the fiber or fiber bunch is moved relative to a stationary application element, or vice versa. In practice, it will be found to be advantageous, when coloring hair, to move the application element relative to the hair strands that have grown on the head and are thus stationary, and to wet the entire hair strand with the product.

It is additionally advantageous to additionally ensure guidance of the fiber or fiber bunch in the application region by means of a barb. This ensures on the one hand that the fiber or fiber bundle can easily be guided into the application region, preferably can easily slide into it; and on the other hand that as soon as it is in that application region, it cannot leave it until the applicator has been pulled through to the end of the hair strand.

It may additionally be useful to arrange the selection element displaceably in order to give the user the capability, despite a compact design for the entire applicator, of neatly selecting an individual hair strand and automatically transporting it back into the application zone. The displaceability is preferably linked to a spring element that holds the selection element in a specific position. Depending on the field of application, this can be either the extended or the retracted position. It is especially advantageous, in the context of displaceable selection elements of this kind, to add to this element a gripping aid that simplifies displacement. Gripping aids of this kind are, for example, applied flutes or rubberized elements that simplify handling especially in a wet environment.

In order to enhance even further the compactness of an apparatus according to the present invention, it may be useful for the selection element already to be equipped with a groove which is identical to the groove that serves for guidance of the fiber bunch or fiber during the application operation. A fiber or fiber bunch can thus be selected via a selection tip on the selection element, slides into the groove present in the selection element, and is transferred by way of the movability of the selection element into the application region of the application element. During the application operation, this groove, for example in combination with an additional barb, holds the fiber or fiber bunch in the application region. Depending on the design of an applicator according to the present invention, it may be advantageous to configure the groove and thus the application direction transversely to the movement axis of the selection element. This ensures, in simple fashion, that the fiber or fiber bundle cannot fall out of the groove during the application operation.

The displaceability of the selection element can be implemented, for example, by means of a simple guide in the form of a slide.

It may additionally be advantageous in the context of an applicator according to the present invention to provide a protective element that protects the application element. This protective element on the one hand prevents contamination of the clothing or hands of the user upon inadvertent contact with the application element, and other hand prevents possible destruction of the application element as a result of contact with the user's hands or with sharp-edged and hard surfaces. Protection of the application element is particularly important when sensitive and fragile application materials are used, for example sintered material. In order further to improve the compactness of the applicator, it is useful for this protective element to serve simultaneously for guidance of the fiber during the application operation. In particular, it is also shaped integrally with the barb that holds the fiber in the application region.

A great advantage of the present invention is that the applicator is usable in any position, including in difficult locations. In order to make absolutely sure that the product leaves the container only when the user wishes, it is advantageous to provide a valve between the container and application element. This valve can, for example, be coupled to the displaceable selection element, so that the displaceability of the selection element closes and opens the valve. In simple configurations, overpressure valves or silicone slit valves are also possible.

Especially when overpressure valves are used, it is advantageous to fabricate the container from elastic material. Elastic plastic such as PE, PVC, or EVOH can be used, for example. An overpressure can be built up inside the elastic container by simply pressing or squeezing the container, causing the contained product to be discharged through the valve.

Connection between the applicator and the container is implemented by way of a plug-in connection, a snap detent connection, or preferably by way of a thread. Each of these connection possibilities can serve both for mechanical attachment and for sealing with respect to the product.

It may furthermore be advantageous for the main axis of the applicator not to run parallel to the main axis of the container. This greatly enhances the ergonomics of the overall apparatus comprising the applicator and container. It is furthermore possible to ensure thereby that even when used overhead, after the selection operation the container is in a position in which product can be discharged from the container onto the application element. The angle between the main axis of the applicator and the main axis of the container is adapted accordingly, within the scope of the present invention, to the geometric requirements of the selection operation and the selection element. Accordingly, a different angle may possibly be ideal according to the invention, depending on the selection element chosen.

In principle, angles in the range between 70° and 20°, by preference between 60° and 30′, particularly preferably between 40° and 50°, very particularly between 43° and 47°, are used. These angle ranges have emerged, surprisingly, as ideal with regard to the handling ergonomics of such applicators.

The subject matter of the invention is furthermore the use of an applicator according to the present invention for the coloring of hairs or hair strands.

Also part of the invention is a method for coloring hairs with an applicator according to the present invention. This method comprises at least a first step, namely gripping the hair or a hair strand with the selection element, and a second step, namely applying the product onto the hair or hair strand with the aid of the application element.

The invention will be presented in further detail in the drawings that follow and in the exemplifying embodiments shown therein.

In the drawings:

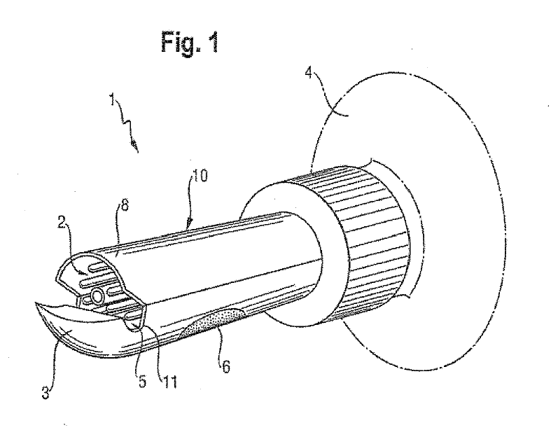

FIG. 1 shows an embodiment of an applicator according to the present invention;

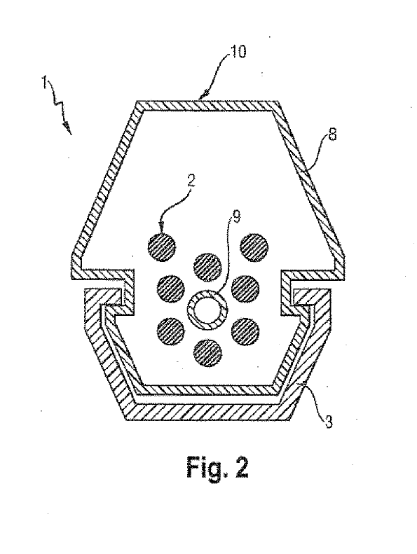

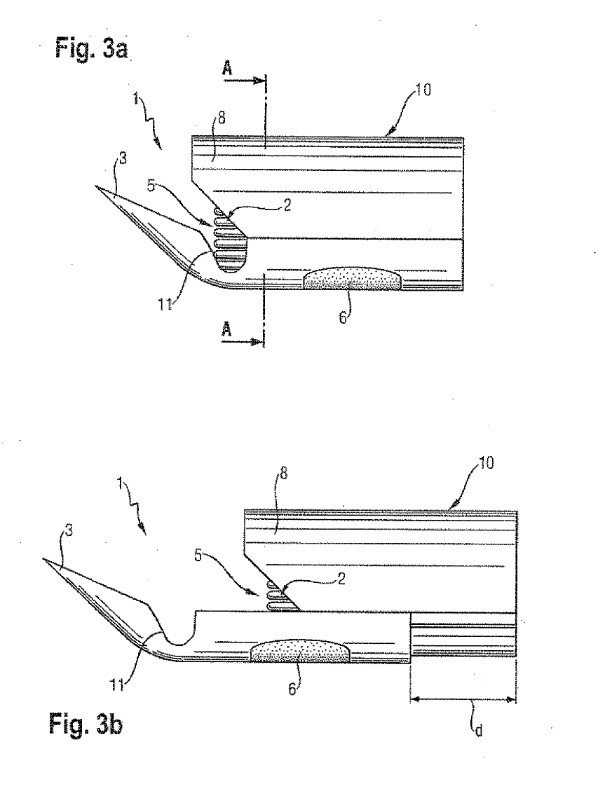

FIG. 2 is a cross section along line A-A in FIG. 3a;

FIG. 3a is a side view of an embodiment of an applicator according to the present invention having a displaceable selection element;

FIG. 3b is a side view of the applicator of FIG. 3a with the selection element extended;

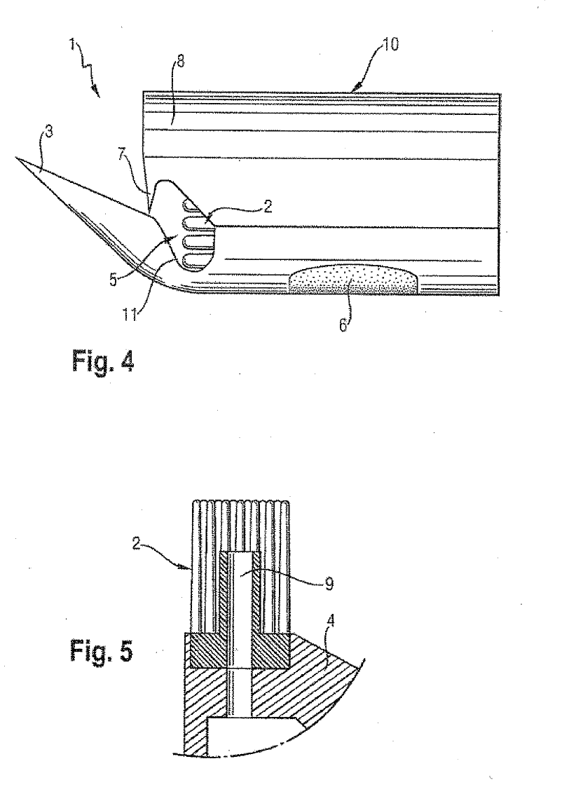

FIG. 4 is a side view of a further embodiment of an applicator according to the present invention, having a barb for securing the application region;

FIG. 5 is a cross section through an application element having bristles;

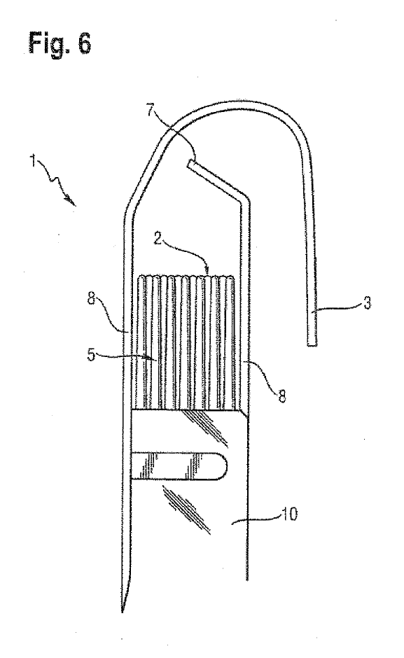

FIG. 6 is side view of a further embodiment of an applicator according to the present invention;

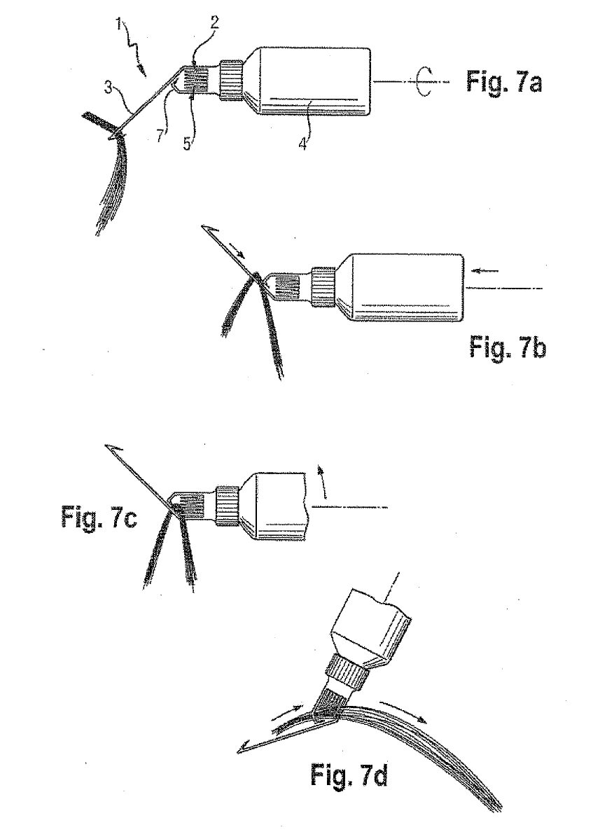

FIGS. 7a to 7d depict a further embodiment of an applicator according to the present invention having a bottle, as well as the four steps of using that applicator;

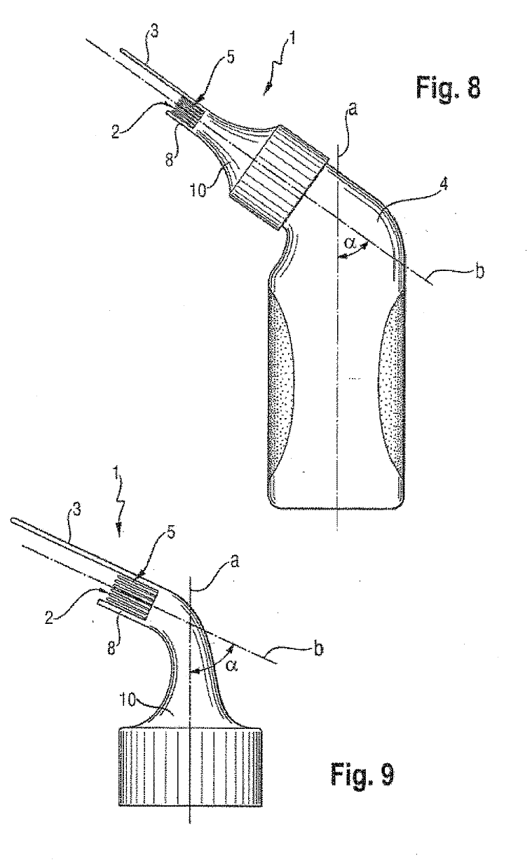

FIG. 8 shows a further embodiment of the invention having an angled applicator;

FIG. 9 shows a further embodiment of an applicator according to the present invention having an angled applicator.

FIG. 1 shows an applicator 1 according to the present invention having a bristle-like application element 2 and a hook-shaped selection element 3. Application element 2 is protected by an extension of the outer wall of applicator 1, which extension serves as a protective element 8. Applicator 1 is configured here as an attachment onto a container 4 containing the product. Groove 11 visible on the side of selection element 2, which groove likewise exists on the back side of the selection element, serves to receive the strand or bunch to be colored during movement of the strand or bunch through application region 5. Depicted on selection element 3 is a gripping aid 6 that makes the applicator easier for the user to hold during the selection operation. The embodiment of an applicator according to the present invention as shown in FIG. 1 can be embodied with both a displaceable and a fixedly attached selection element 3.

FIGS. 2, 3a, and 3b show a further embodiment of the present invention. In this embodiment, selection element 3 is configured movably. FIG. 2 shows a cross section along viewing line A-A in FIG. 3a, clearly showing applicator housing 10 that is integral with protective element 8, as well the displaceable selection element 3 attached thereto. Displaceability is guaranteed here by the configuration of selection element 3 as a slide that is guided in two grooves 11 of applicator 1. Also evident from the cross section in FIG. 2 is the bristle-shaped application element 2. The invention is, of course, not limited to the number or arrangement of such bristles to form an application element 2. Container opening 9 is visible centrally inside application element 2. The product contained in container 4 emerges from this opening and is applied by application element 2 onto the hair strand that slides past during the application operation. If sintered materials or other, for example fiber-containing, materials are used for application element 2, the latter can completely fill up container opening 9, provided application element 2 is both capable of conveying product and in contact with the interior of container 4.

FIG. 3a is a side view of this embodiment of applicator 1.

FIG. 3b shows applicator 1 of FIG. 3a with selection element 3 extended. The extension travel d is to be selected so that during the selection operation, a sufficient spacing is ensured between application element 2 and the tip of selection element 3. By preference, d corresponds to approximately 50% to 200% of the maximum development of application region 5 in the direction that is substantially parallel to the displacement axis of selection element 3, particularly preferably 70% to 150% of that development, very particularly preferably 80% to 120%.

FIG. 4 shows a variation of applicator 1 depicted in FIGS. 2, 3a, and 3b. It has additionally had added to it a barb 7 that is embodied integrally with protective element 8. This barb 7 serves to securely hold in application region 5, during the application operation, hair strand bunches that have been selected and grasped in groove 11. Barb 7 thus performs a guidance function for the hair strand during movement of the hair strand through application element 2.

FIG. 5 shows a cross section of an application element 2 according to the present invention. This embodiment comprises bristles as well as a container opening 9 that is arranged inside the bristles. Container 4 is also depicted in part. The product emerging from container opening 9 becomes distributed in the bristles of application element 2. During the application operation, the bristles of application element 2 distribute the product contained in the bristles onto the surface of the hair strand to be colored.

FIG. 6 shows a side view of applicator 1 that is depicted in section in FIG. 5. Accompanying this applicator are a selection element 3 and a protective element 8. Selection element 3 is configured in this embodiment as a long curved hook. In this embodiment, the hair strand to be colored can be gripped by selection element 3 and, with the aid of that selection element 3, threaded into application region 5. In this embodiment, protective element 8 serves to protect selection element 3 from soiling as a result of contact with application element 2. Barb 7 and protective elements 8 here serve additionally to guide the hair strand in application region 5 during the application operation.

FIGS. 7a, 7b, 7c, and 7d depict the application operation of a further exemplifying embodiment of the present invention. Applicator 1 here comprises an elongated selection element 3 that comprises a crochet-hook-shaped element at its end. This crochet-hook-shaped element serves to select individual hairs or hair strands. Rotation of the container, as indicated in FIG. 7a by the arrow around the main axis of the container, causes the hair strand to slide into the position according to FIG. 7b. It is now located on the outer side of barb 7 (embodied integrally with protective element 8), outside application region 5. A movement of container 4 with applicator 1 in the arrow direction shown in FIG. 7b causes the hair or hair strand to slide past the barb into application region 5. This situation is depicted in FIG. 7c. The hair strand is now in contact with application element 2 in application region 5, and is held in that application region by protective element 8 and by barb 7. By means of a tilt container 4 as indicated by the arrow in FIG. 7c, and optionally by pressure on container 4, product is then discharged onto application element 2. During this product discharge, the user of applicator 1, as depicted in FIG. 7d, pulls the applicator along the hair strand or the hair. The hair or hair strand thus passes through application region 5 over its entire length, and is thus provided with the product. Selection element 3 remains clean during the entire operation, since it does not come directly into contact either with product or with application element 2 or with hair that has already been colored. This operation is then repeated for each further strand that is to be treated.

The essential basic steps of the operation described here likewise apply to all other embodiments of the invention that are explained here.

FIGS. 8 and 9 show two further embodiments of applicator 1 according to the present invention that are freely combinable, in terms of their basic idea, with the embodiments described above. What is essential here is the fact that an angle α, which is not equal to 180°, exists between main axis a of the container and main axis b of the applicator. This is achieved on the one hand, as depicted in FIG. 8, by way of an opening 9 of container 4 tilted to one side, on which opening an applicator 1 according to the present invention is secured. Another possibility, for example in order to ensure usability with standard bottles that already exist, is to provide the necessary angle in applicator 1 itself This is depicted in FIG. 9.

Applicators 1 in FIGS. 8 and 9 also present a further particular simple possibility for configuring an applicator according to the present invention. Selection element 3 is made up of an elongated, substantially spatula-shaped element that adjoins application element 2. Located on the other side of application element 2 is protective element 8, which serves simultaneously to guide the hair strand during the application operation. The angle α, which in FIGS. 8 and 9 is equal to approximately 45°, provides easier handling for the user of applicator 1. This is advantageous in particular when the applicators depicted in FIGS. 8 and 9 are used in the application operation according to FIGS. 7a to 7d, since the last step (the tilt from FIG. 7c to FIG. 7d) is no longer necessary. It is, however, useful in this case to provide on container opening 9 a valve that prevents free outflow of product from container 4.

The embodiment possibilities depicted here represent merely examples of the present invention. The invention is, of course, not limited to these exemplifying embodiments.

1. An applicator for applying a product onto keratin-containing a fiber or fiber bundle, comprising
an application element and
a selection element,
wherein the selection element is physically separated from the application element, whereby the selection element is protected from contamination by the product before, during, or after an application operation; and
wherein the application element is connectable to the opening of a container that contains the product, whereby the application element can be supplied with product from the container.

2. The applicator of claim 1, wherein the application element comprises elements selected from the group consisting of bristles, comb elements, sintered elements, and sponge elements.

3. The applicator of claim 1, wherein the selection element is elongated and substantially spatula-shaped, and optionally comprises a barb.

4. The applicator of claim 1, further comprising an application region comprising a guide for the fiber or fiber bundle during an application operation.

5. The applicator of claim 4, wherein the guide is formed by a groove.

6. The applicator of claim 4, wherein the guide is secured by a barb.

7. The applicator of claim 1, wherein the selection element is displaceable.

8. The applicator of claim 7, further comprising a spring that holds the displaceable selection element in a position.

9. The applicator of claim 8, wherein the position is a retracted position for an application operation.

10. The applicator of claim 7, wherein the displaceable selection element further comprises a gripping aid.

11. The applicator of claim 7, wherein the displaceable selection element further comprises a groove to guide the fiber or fiber bundle during the application operation.

12. The applicator of claim 11, wherein the groove lies substantially perpendicular to the movement axis of the displaceable selection element.

13. The applicator of claim 7, wherein the displaceable selection element is embodied as a slide.

14. The applicator of claim 1, further comprising a protective element that protects the application element.

15. The applicator of claim 1, wherein a valve is arranged between the container and the application element.

16. The applicator of claim 15, wherein the valve is coupled to the selection element and the selection element is displaceable.

17. The applicator of claim 15, wherein the valve is an overpressure valve.

18. The applicator of claim 1, wherein the applicator is connected detachably to the container via a thread or a plug-in connection or a snap detent connection.

19. The applicator of claim 1, wherein the selection element comprises a curved hook-shaped development.

20. The applicator of claim 1, wherein the selection element comprises a crochet-hook shaped development.

21. The applicator of claim 1, wherein the main axis of the container is not parallel to the main axis of the applicator.

22. The applicator of 21, wherein the angle between the main axis of the container and the main axis of the applicator is between 70° and 20°.

23. (canceled)

24. A method for coloring a hair using the applicator of claim 1, wherein the method comprises the steps of:
a) gripping the hair with the selection element,
b) transferring the hair into an application region of the applicator,
c) applying the product onto the hair with the aid of the application element by relative movement between the application element and the hair.
